(19) United States
(12) Patent Application Publication
(10) Pub. No.: US 2025/0110347 A1
(43) Pub. Date: Apr. 3, 2025

(54) OPTICAL DEVICE AND DISPLAY DEVICE

(71) Applicant: Nichia Corporation, Anan-shi (JP)

(72) Inventors: Wataru KITAHARA, Kamiina-gun (JP); Takanori ARUGA, Suwa-gun (JP)

(21) Appl. No.: 18/899,721

(22) Filed: Sep. 27, 2024

(30) Foreign Application Priority Data
Sep. 29, 2023 (JP) 2023-170512

(51) Int. Cl. G02B 27/28; G02B 27/10; G02B 27/14

(52) U.S. Cl. CPC G02B 27/286; G02B 27/1006; G02B 27/145; G02B 27/288

(57) ABSTRACT

An optical device includes a laser light source; a first optical integrator configured to transmit laser light emitted from the laser light source; a second optical integrator configured to transmit the laser light emitted from the first optical integrator; and a retardation plate disposed between the laser light source and the second optical integrator, and configured to transmit a portion of the laser light so as to rotate a polarization of the transmitted portion of the laser light by 90 degrees.

### CROSS-REFERENCE TO RELATED APPLICATIONS

This application is based on and claims priority to Japanese Patent Application No. 2023-170512, filed on Sep. 29, 2023, the entire contents of which are incorporated herein by reference.

### TECHNICAL FIELD

The present disclosure relates to an optical device and a display device.

### BACKGROUND

Optical devices included in a display device or the like, which displays an image by using laser light, and configured to emit laser light are known.

For example, Japanese Patent Publication No. 2011-242537 describes a light source device in which a half-wave plate rotates the polarization of laser light output from a laser light source by 90 degrees in order to reduce speckle noise caused by scattering of the laser light.

However, the light source device described in Japanese Patent Publication No. 2011-242537 uses only the polarization of the laser light output from the laser light source, and thus there is still room for improvement in speckle noise reduction performance.

### SUMMARY

One or more embodiments of the present disclosure are directed to providing an optical device in which speckle noise reduction performance is improved.

An optical device according to an embodiment of the present disclosure includes a laser light source; a first optical integrator configured to transmit laser light emitted from the laser light source; a second optical integrator configured to transmit the laser light emitted from the first optical integrator; and a retardation plate disposed between the laser light source and the second optical integrator, and configured to transmit a portion of the laser light so as to rotate a polarization of the transmitted portion of the laser light by 90 degrees.

### BRIEF DESCRIPTION OF THE DRAWINGS

Other objects and further features of the present invention will be apparent from the following detailed description when read in conjunction with the accompanying drawings, in which:

FIG. 1 schematically illustrates a cross-sectional view of an optical device according to a first embodiment;

FIG. 2 schematically illustrates a plan view of the optical device according to a first example of the positional relationship between a laser light source and a retardation plate;

FIG. 3 schematically illustrates a perspective view of a first fly-eye lens included in a first optical integrator of the optical device according to the first embodiment;

FIG. 4 schematically illustrates a perspective view of a third fly-eye lens included in a second optical integrator of the optical device according to the first embodiment;

FIG. 5 schematically illustrates a cross-sectional view of a second illumination optical system, illustrating a state in which two orthogonal polarized light beams are incident on an irradiation surface in the optical device according to the first embodiment;

FIG. 6 schematically illustrates a plan view of the optical device according to a second example of the positional relationship between the laser light source and the retardation plate;

FIG. 7 schematically illustrates a cross-sectional view of an optical device according to a second embodiment;

FIG. 8 schematically illustrates a cross-sectional view of the second illumination optical system in the optical device according to the second embodiment, illustrating a state in which two orthogonal polarized light beams are incident on the irradiation surface;

FIG. 9 schematically illustrates a cross-sectional view of an optical device according to a third embodiment, illustrating a first example of the configuration of a laser light source and the vicinity thereof;

FIG. 10 schematically illustrates a cross-sectional view of the optical device according to the third embodiment, illustrating a second example of the configuration of the laser light source and the vicinity thereof;

FIG. 11 schematically illustrates a plan view of the optical device according to the third embodiment, illustrating a first example of the positional relationship between combined light and the retardation plate;

FIG. 12 schematically illustrates a plan view of the optical device according to the third embodiment, illustrating a second example of the positional relationship between the combined light and the retardation plate;

FIG. 13 schematically illustrates a cross-sectional view of an optical device according to a fourth embodiment; and

FIG. 14 schematically illustrates a cross-sectional view of a display device according to a fifth embodiment.

### DETAILED DESCRIPTION

Optical devices and a display device according to embodiments of the present disclosure will be described in detail below with reference to the accompanying drawings. The embodiments described below exemplify the optical devices and the display device to give a concrete form to the technical ideas of the present disclosure, and the scope of the disclosure is not limited to the embodiments described below. In addition, unless otherwise specified, the dimensions, materials, shapes, relative arrangements, and the like of components described in the embodiments are not intended to limit the scope of the present disclosure thereto, but are described as examples. The sizes, positional relationships, and the like of members illustrated in the drawings may be exaggerated for clearer illustration. Further, in the following description, the same names and reference numerals denote the same or similar members, and a detailed description thereof will be omitted as appropriate. An end view illustrating only a cut surface may be used as a cross-sectional view.

In the drawings, in order to indicate directions, an orthogonal coordinate system having an X-axis, a Y-axis, and a Z-axis is used. The X-axis, the Y-axis, and the Z-axis are orthogonal to one another. A side indicated by an arrow in the X direction along the X-axis is referred to as a +X side, and a side opposite to the +X side is referred to as a −X side. A side indicated by an arrow in the Y direction along the Y-axis is referred to as a +Y side, and a side opposite to the +Y side is referred to as a −Y side. A side indicated by an arrow in the Z direction along the Z-axis is referred to as a +Z side, and a side opposite to the +Z side is referred to as a −Z side.

The Z-axis is along a direction normal to a retardation plate included in each of the optical devices according to the embodiments. Further, the optical devices according to the embodiments emit laser light to the +Z side, and the +Z direction may be referred to as a light transmitting direction. The expression “in a plan view” used in the embodiments refers to viewing an object from the +Z side or the −Z side. A plan view of an object means an illustration of the object in a plan view. However, these expressions do not limit the orientations of the optical devices and the display device during use, and the orientations of the optical devices and the display device are arbitrary.

In the following embodiments, each of “along the X-axis,” “along the Y-axis,” and “along the Z-axis” includes a case where an object is at an inclination within a range of ±10 degrees with respect to the corresponding one of the axes. In the embodiments, each of the terms “orthogonal” and “perpendicular” may include a deviation within ±10 degrees with respect to 90 degrees. Further, a 90-degree rotation may include a deviation within ±10 degrees. Further, one-half of an object may include a deviation within ±10%.

Further, in the present specification and the claims, if there are multiple components and these components are to be distinguished from one another, the components may be distinguished by adding terms “first,” “second,” and the like before the names of the components. Further, objects to be distinguished may be different between the specification and the claims. Therefore, even if a component recited in the claims is denoted by the same reference numeral as that of a component described in the present specification, an object specified by the component recited in the claims is not necessarily identical with an object specified by the component described in the specification.

### First Embodiment

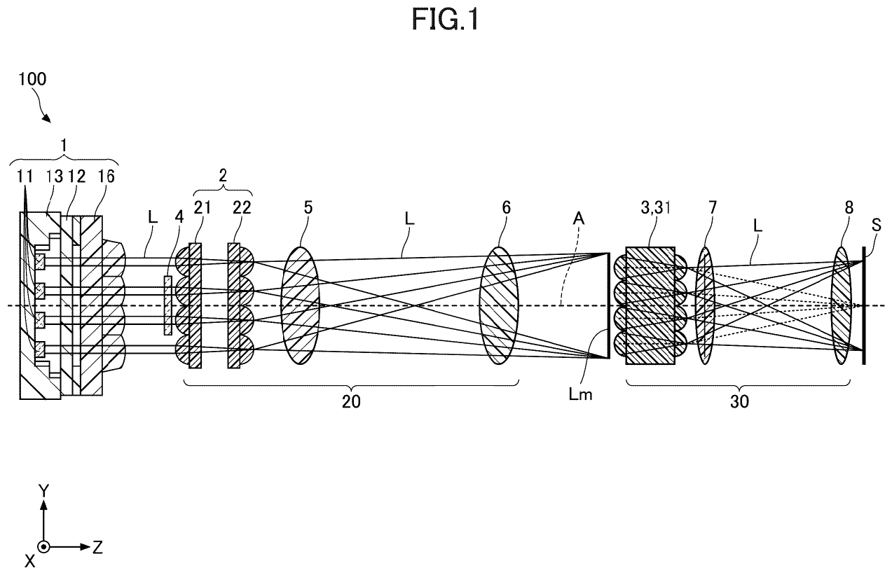

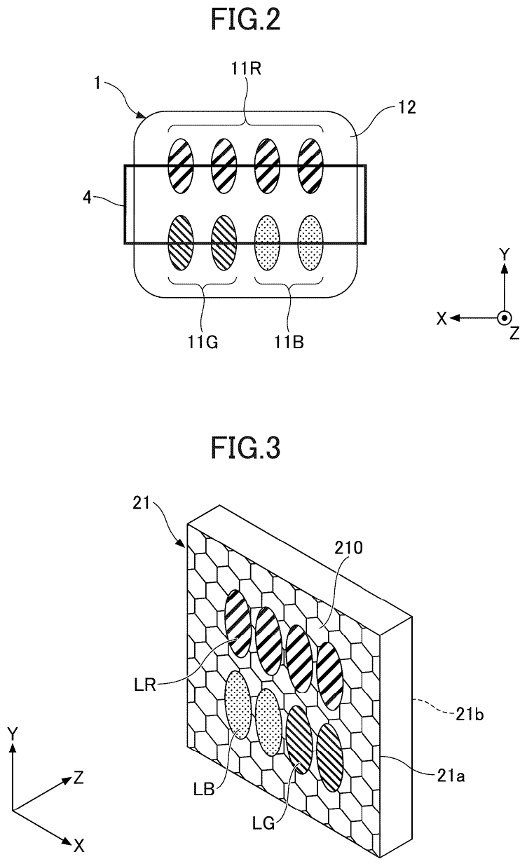

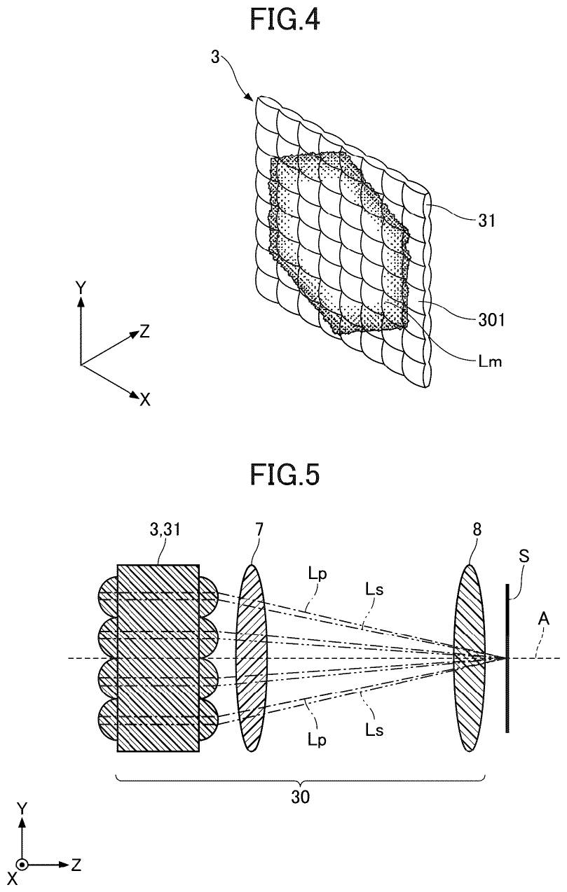

An optical device according to a first embodiment will be described with reference to FIG. 1 to FIG. 5. FIG. 1 schematically illustrates a cross-sectional view of an example of an optical device 100 according to the first embodiment. FIG. 1 illustrates a cross section of the optical device 100 taken along an imaginary plane (for example, the YZ plane) including an optical axis A of the optical device 100. The optical axis A of the optical device 100 is an axis passing through the center of a first optical integrator 2 of the optical device 100. FIG. 2 schematically illustrates a plan view of the optical device 100, illustrating a first example of the positional relationship between a laser light source 1 and a retardation plate 4 in the optical device 100. FIG. 3 schematically illustrates a perspective view of a first fly-eye lens 21 included in the first optical integrator 2 of the optical device 100. FIG. 4 schematically illustrates a perspective view of a third fly-eye lens 31 included in a second optical integrator 3 of the optical device 100. FIG. 5 schematically illustrates a cross-sectional view of a second illumination optical system 30, illustrating a state in which two orthogonal polarized light beams are incident on an irradiation surface S in the optical device 100. FIG. 5 illustrates a cross section of the optical device 100 taken along an imaginary plane (for example, the YZ plane) including the optical axis A of the optical device 100.

The optical device 100 includes the laser light source 1, the first optical integrator 2 configured to transmit laser light L emitted from the laser light source 1, and the second optical integrator 3 configured to transmit the laser light L transmitted through the first optical integrator 2. The optical device 100 further includes the retardation plate 4 disposed between the laser light source 1 and the second optical integrator 3 and configured to transmit a portion of the laser light L so as to rotate the polarization of the transmitted portion of the laser light L by 90 degrees. In addition, in the example illustrated in FIG. 1, the optical device 100 includes a first lens 5, a second lens 6, a third lens 7, and a fourth lens 8. The first optical integrator 2, the first lens 5, and the second lens 6 constitute a first illumination optical system 20. The second optical integrator 3, the third lens 7, and the fourth lens 8 constitute the second illumination optical system 30. The second optical integrator 3 can include the third fly-eye lens 31.

In the example illustrated in FIG. 1, the laser light source 1 includes semiconductor a plurality of laser elements 11, a substrate 13 having a recessed portion on the surface on the +Z side thereof, a cover member 12, and an optical member 16. The plurality of semiconductor laser elements 11 are disposed in the recessed portion of the substrate 13. The recessed portion of the substrate 13 is sealed by the cover member 12, and the optical member 16 is disposed on the surface on the +Z side of the cover member 12. The semiconductor laser elements 11 can emit the laser light L in accordance with a current or the like supplied via the substrate 13.

As illustrated in FIG. 2, the laser light source 1 includes four first semiconductor laser elements 11R that emit red laser light, two second semiconductor laser elements 11G that emit green laser light, and two third semiconductor laser elements 11B that emit blue laser light. That is, the plurality of semiconductor laser elements 11 illustrated in FIG. 1 include the four first semiconductor laser elements 11R, the two second semiconductor laser elements 11G, and the two third semiconductor laser elements 11B. Further, the laser light L illustrated in FIG. 1 includes the laser light emitted from each of the four first semiconductor laser elements 11R, the two second semiconductor laser elements 11G, and the two third semiconductor laser elements 11B.

In the example illustrated in FIG. 1 and FIG. 2, the laser light source 1 emits linearly-polarized laser light L from the semiconductor laser elements 11. The laser light L is, for example, P-polarized light. The retardation plate 4 transmits a portion (i.e., a portion but not all or only a selective portion) of the laser light L emitted from the semiconductor laser elements 11 so as to rotate the polarization direction of the transmitted portion of the laser light L by 90 degrees with respect to the P-polarized light, thereby emitting S-polarized light. Of the laser light L, the P-polarized light that was not transmitted through the retardation plate 4 and the S-polarized light that was transmitted through the retardation plate 4 are incident on the first optical integrator 2.

The retardation plate 4 is, for example, a half-wave plate. In the example illustrated in FIG. 2, the shape of the retardation plate 4 in a plan view is a substantially rectangular shape with the longer side being in the lateral direction (for example, the X direction) orthogonal to the vertical direction. However, the shape of the retardation plate 4 in a plan view may be a substantially circular shape, a substantially elliptical shape, a substantially polygonal shape, or the like. The normal direction to the retardation plate 4 substantially coincides with, for example, the optical axis A. The half-wave plate may be composed of a birefringent crystal or may be composed of a birefringent resin. The retardation plate 4 is disposed such that the optic axis of the half-wave plate is inclined by 45 degrees with respect to the polarization direction of the linearly-polarized laser light L. With this configuration, the retardation plate 4 can rotate the polarization of laser light, of the laser light L, transmitted through the retardation plate 4 by 90 degrees.

In the example illustrated in FIG. 1, each of the first optical integrator 2 and the second optical integrator 3 generates luminous flux having a uniform illuminance from the laser light L emitted from the laser light source 1. The laser light L from the laser light source 1 transmitted through the first optical integrator 2, then transmitted through the first lens 5 and the second lens 6, and is incident on the second optical integrator 3. The laser light L that has been transmitted through the second optical integrator 3 is transmitted through the third lens 7 and the fourth lens 8, and is then emitted from the optical device 100. The irradiation surface S is irradiated with the laser light L emitted from the optical device 100. The irradiation surface S is, for example, a screen.

In the case of laser light which is coherent light, interference tends to occur as compared to the case of incoherent light. For that reason, when the irradiation surface S is irradiated with laser light of the coherent light, speckle noise may be generated more significantly due to interference of light scattering on the irradiation surface S. In a case where an image is displayed by using laser light emitted from an optical device, such generation of speckle noise would cause luminance unevenness and/or color unevenness, and thus the quality of the image would be degraded.

The optical device 100 can emit two orthogonal polarized light beams by allowing the retardation plate 4 to rotate the polarization of a portion of the laser light L emitted from the laser light source 1 by 90 degrees. The two orthogonal polarized light beams do not interfere with each other, and thus the optical device 100 can suppress speckle noise by emitting the two orthogonal polarized light beams. In the present specification, this is referred to as a “speckle noise reduction effect by polarization multiplexing”.

Further, the optical device 100 includes the two optical integrators, that is, the first optical integrator 2 and the second optical integrator 3, and thus the angular difference among the incident angles of laser light L emitted from the optical device 100 and incident on the irradiation surface S can be increased. The angular difference among the incident angles of light on the irradiation surface S means the angular difference among an incident angle of one light beam incident on the irradiation surface S and the incident angles of other light beams incident on the irradiation surface S. The angular difference among the incident angles of light on the irradiation surface S may be rephrased as a range of the incident angles of light on the irradiation surface S. The larger the angular difference among the incident angles of light beams, the less likely the incident light beams interfere with each other. In the optical device 100, speckle noise can be suppressed by including the two optical integrators, that is, the first optical integrator 2 and the second optical integrator 3, and increasing the angular difference among the incident angles of light. In the present disclosure, this is referred to as a “speckle noise reduction effect by angular multiplexing”. Effects of angular multiplexing will be separately described with reference to FIG. 5.

In the present embodiment, the optical device 100 in which speckle noise reduction performance can be improved can be provided by utilizing both polarization multiplexing and angular multiplexing. For example, speckle noise reduction performance of the optical device 100 can be improved by utilizing both polarization multiplexing and angular multiplexing, as compared to when only polarization multiplexing is used.

Further, in the optical device 100, the retardation plate 4 can transmit one-half of laser light L emitted from the laser light source 1. For example, as illustrated in FIG. 2, the retardation plate 4 can be disposed so as to transmit one-half of laser light L emitted from one of the semiconductor laser elements 11. In the example illustrated in FIG. 2, the retardation plate 4 is disposed so as to transmit one-half of each of four laser light beams L emitted from the four first semiconductor laser elements 11R, one-half of each of two laser light beams L emitted from the two second semiconductor laser elements 11G, and one-half of each of two laser light beams L emitted from the two third semiconductor laser elements 11B. With this configuration, each of the laser light beams L emitted from the four first semiconductor laser elements 11R, the two second semiconductor laser elements 11G, and the two third semiconductor laser elements 11B can be divided into two orthogonal polarized light beams. By dividing each of the laser light beams into the two orthogonal polarized light beams, the speckle noise reduction effect by polarization multiplexing can be substantially maximized, and speckle noise can be reduced as compared to when polarization multiplexing is not utilized.

The laser light source 1 is a light emitting device including the plurality of semiconductor laser elements 11. Each of the semiconductor laser elements 11 emits laser light L. Accordingly, the optical device 100 can emit bright light as compared to when light other than laser light is emitted and when only one semiconductor laser element is used to emit laser light.

Further, the laser light source 1 can emit a plurality of laser beams L having different colors. Accordingly, the optical device 100 can emit mixed color light in which the colors of the plurality of laser beams L are mixed.

The first optical integrator 2 includes the first fly-eye lens 21 and a second fly-eye lens 22. Each of the first fly-eye lens 21 and the second fly-eye lens 22 is a plate-shaped member having a first surface 21a and a second surface 21b opposite to the first surface 21b. Each of the first surface 21a and the second surface 21b is a plane (for example, the XY plane) orthogonal to the optical axis A. The first surface 21a includes a plurality of first convex surfaces 210 arranged along a plane orthogonal to the optical axis A. The first fly-eye lens 21 and the second fly-eye lens 22 are arranged such that their second surfaces 21b face each other. The first fly-eye lens 21 and the second fly-eye lens 22 preferably have the same shape in terms of productivity, but may have different shapes. The first fly-eye lens 21 and the second fly-eye lens 22 may be produced as a monolithic member instead of separate members.

In the example illustrated in FIG. 3, each of the plurality of first convex surfaces 210 included in the first fly-eye lens 21 has a substantially hexagonal shape in a plan view. The plurality of first convex surfaces 210 are arranged such that there is substantially no gap in a plan view. The shape of each of the first convex surfaces 210 in a plan view is not limited to a substantially hexagonal shape, and may be a substantially circular shape, a substantially elliptical shape, a substantially rectangular shape, a substantially polygonal shape other than a hexagonal shape, or the like. Four first laser light beams LR emitted from the four first semiconductor laser elements 11R, two second laser light beams LG emitted from the two second semiconductor laser elements 11G, and two third laser light beams LB emitted from the two third semiconductor laser elements 11B are transmitted through the optical member 16 illustrated in FIG. 1 and are incident on the first fly-eye lens 21 as substantially parallel light beams.

The second optical integrator 3 is disposed at a position substantially conjugate with the first optical integrator 2 through the first lens 5 and the second lens 6. In addition, the first illumination optical system 20 is configured such that magnified conjugate images of the plurality of first convex surfaces 210 of the first optical integrator 2 substantially overlap each other in the vicinity of the position where the second optical integrator 3 is disposed. As a result, as illustrated in FIG. 4, in the vicinity of the position where the second optical integrator 3 is disposed, a magnified conjugate image, in which the magnified conjugate images of the plurality of first convex surfaces 210 substantially overlap each other, is obtained by mixed color light Lm of red laser light, green laser light, and blue laser light that have passed through the plurality of first convex surfaces 210.

In the example illustrated in FIG. 4, the third fly-eye lens 31 is a plate-shaped member including a plurality of third convex surfaces 301 arranged along a plane orthogonal to the optical axis A. The plurality of third convex surfaces 301 are connected to each other.

Each of the first optical integrator 2, the second optical integrator 3, the first lens 5, the second lens 6, the third lens 7, and the fourth lens 8 includes a resin or glass optically transmissive to the laser light L emitted from the laser light source 1. As used herein, “optically transmissive” refers to a property of having a light transmittance of preferably 60% or more with respect to the laser light L.

In the example illustrated in FIG. 5, P-polarized light Lp and S-polarized light Ls, which are two polarized light beams orthogonally polarized to each other, are irradiated onto the irradiation surface S through the second illumination optical system 30. The P-polarized light Lp is, of the laser light L emitted from the laser light source 1, laser light that was not transmitted through the retardation plate 4. The S-polarized light Ls is, of the laser light L emitted from the laser light source 1, laser light that was transmitted through the retardation plate 4.

As illustrated in FIG. 1, in the optical device 100, the retardation plate 4 can be disposed between the laser light source 1 and the first optical integrator 2. With this configuration, as illustrated in FIG. 5, P-polarized light beams Lp are incident on the irradiation surface S from directions substantially symmetrical to each other with respect to the optical axis A and S-polarized light beams Ls are incident on the irradiation surface S from directions substantially symmetrical to each other with respect to the optical axis A. As a result, the angular difference among the incident angles of the P-polarized light beams Lp on the irradiation surface S and the angular difference among the incident angles of the S-polarized light beams Ls on the irradiation surface S are increased, as compared to when P-polarized light beams Lp and S-polarized light beams Ls are not incident on the irradiation surface S from directions symmetrical with respect to the optical axis A. Accordingly, in the optical device 100, the speckle noise reduction effect by angular multiplexing can be increased as compared to when light beams are not incident on the irradiation surface S from directions symmetrical with respect to the optical axis A.

In the optical device 100, the number, the arrangement, and the like of the semiconductor laser elements 11 included in the laser light source 1 can be changed as appropriate. The configuration and the arrangement of components of each of the first illumination optical system 20 and the second illumination optical system 30 can also be changed as appropriate. Further, the laser light source 1 is not limited to one that emits a plurality of laser light beams L having different colors, and may be one that emits a monochromatic laser beam L. This case can also reduce speckle noise of the optical device 100.

### <Another Example of Positional Relationship Between Laser Light Source 1 and Retardation Plate 4>

In addition to the first example illustrated in FIG. 2, various modifications of the positional relationship between the laser light source 1 and the retardation plate 4 are possible. In the following, another example of the positional relationship between the laser light source 1 and the retardation plate 4 will be described. The same names and reference numerals as those in the above-described example or embodiment denote the same or similar members or components, and a detailed description thereof will be omitted as appropriate. The same applies to other embodiments described later.

### Second Example

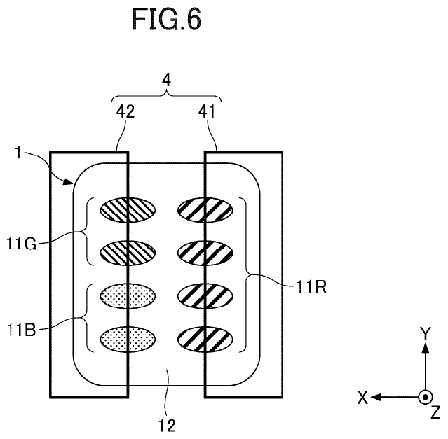

FIG. 6 schematically illustrates a plan view of the optical device 100, illustrating a second example of the positional relationship between the laser light source 1 and the retardation plate 4 in the optical device 100. In the example illustrated in FIG. 6, the retardation plate 4 includes a first retardation plate 41 and a second retardation plate 42.

Each of the first retardation plate 41 and the second retardation plate 42 is, for example, a half-wave plate. Each of the first retardation plate 41 and the second retardation plate 42 is disposed such that the optic axis of the half-wave plate is inclined by 45 degrees with respect to the polarization direction of linearly polarized incident light. Accordingly, the retardation plate 4 can rotate the polarization of laser light, of the linearly polarized incident light, transmitted through each of the first retardation plate 41 and the second retardation plate 42 by 90 degrees.

The first retardation plate 41 is disposed so as to transmit one-half of each of four laser light beams emitted from the four first semiconductor laser elements 11R. The second retardation plate 42 is disposed so as to transmit one-half of each of two laser light beams emitted from the two second semiconductor laser elements 11G and transmit one-half of each of two laser light beams emitted from the two third semiconductor laser elements 11B. Accordingly, the retardation plate 4 can divide each of the laser light beams emitted from the four first semiconductor laser elements 11R, the two second semiconductor laser elements 11G, and the two third semiconductor laser elements 11B into two orthogonal polarized light beams. By dividing each of the laser light beams into the two orthogonal polarized light beams, the speckle noise reduction effect by polarization multiplexing can be substantially maximized, and speckle noise can be reduced as compared to when polarization multiplexing is not utilized.

### Second Embodiment

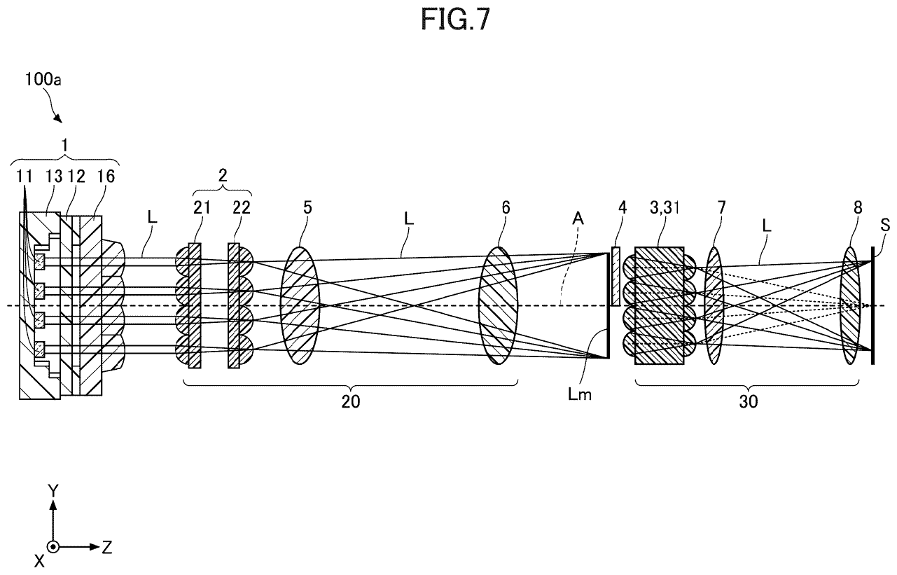

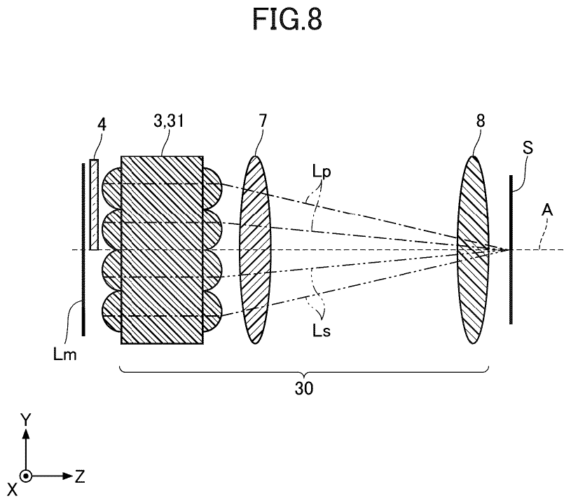

An optical device according to a second embodiment will be described with reference to FIG. 7 and FIG. 8. FIG. 7 schematically illustrates a cross-sectional view of an optical device 100a according to the second embodiment. FIG. 7 illustrates a cross section of the optical device 100a taken along an imaginary plane (for example, the YZ plane) including an optical axis A of the optical device 100a. FIG. 8 schematically illustrates a cross-sectional view of the second illumination optical system 30, illustrating a state in which two orthogonal polarized light beams of the optical device 100a are incident on the irradiation surface S. FIG. 8 illustrates a cross section of the second illumination optical system 30 taken along an imaginary plane (for example, the YZ plane) including the optical axis A.

The second embodiment differs from the first embodiment in that the retardation plate 4 is disposed between the first optical integrator 2 and the second optical integrator 3. In the example illustrated in FIG. 7 and FIG. 8, in the vicinity of the position where the second optical integrator 3 is disposed, the retardation plate 4 is disposed so as to transmit one-half of mixed color light Lm obtained by the first illumination optical system 20.

In the example illustrated in FIG. 8, P-polarized light Lp and S-polarized light Ls, which are two orthogonal polarized light beams, are irradiated onto the irradiation surface S through the second illumination optical system 30. The P-polarized light Lp is mixed color light, of the mixed color light Lm, that has not been transmitted through the retardation plate 4. The S-polarized light Ls is mixed color light, of the mixed color light Lm, that has been transmitted through the retardation plate 4.

In the optical device 100a, the retardation plate 4 is disposed between the first optical integrator 2 and the second optical integrator 3. Thus, as illustrated in FIG. 8, the P-polarized light Lp and the S-polarized light Ls are incident on the irradiation surface S from directions substantially symmetrical with respect to the optical axis A. That is, in the example illustrated in FIG. 8, most of the P-polarized light beams Lp pass through a space on the +Y side relative to the optical axis A and are emitted to the irradiation surface S, and most of the S-polarized light beams Ls pass through a space on the −Y side relative to the optical axis A and are emitted to the irradiation surface S. As a result, the angular difference among the incident angles of P-polarized light beams Lp on the irradiation surface S and the angular difference among the incident angles of S-polarized light beams Ls on the irradiation surface S are increased. Accordingly, in the optical device 100a, the speckle noise reduction effect by angular multiplexing can be increased.

In the optical device 100a, each of the angular difference among the incident angles of the P-polarized light beams Lp on the irradiation surface S and the angular difference among the incident angles of the S-polarized light beams Ls on the irradiation surface S is halved, as compared to the cases where P-polarized light beams Lp are incident on the irradiation surface S from directions substantially symmetrical to each other with respect to the optical axis A and where S-polarized light beams Ls are incident on the irradiation surface S from directions substantially symmetrical to each other with respect to the optical axis A in the first embodiment (see FIG. 5). Therefore, in the optical device 100a, the speckle noise reduction effect by angular multiplexing is reduced as compared to that is the first embodiment.

### Third Embodiment

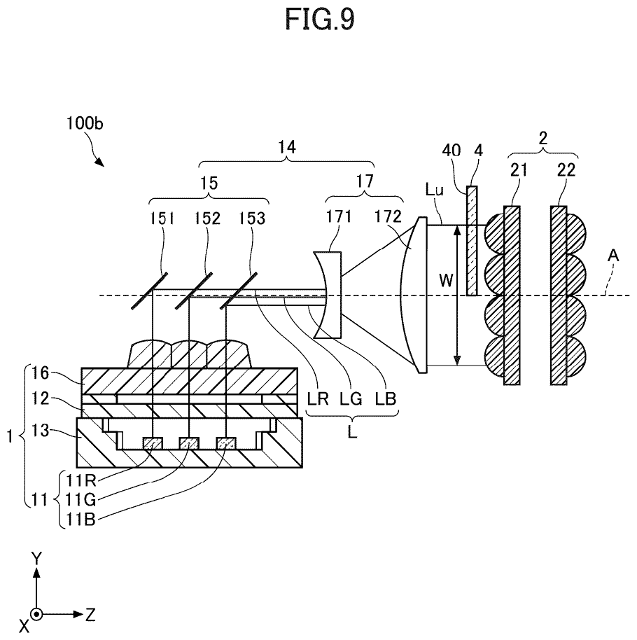

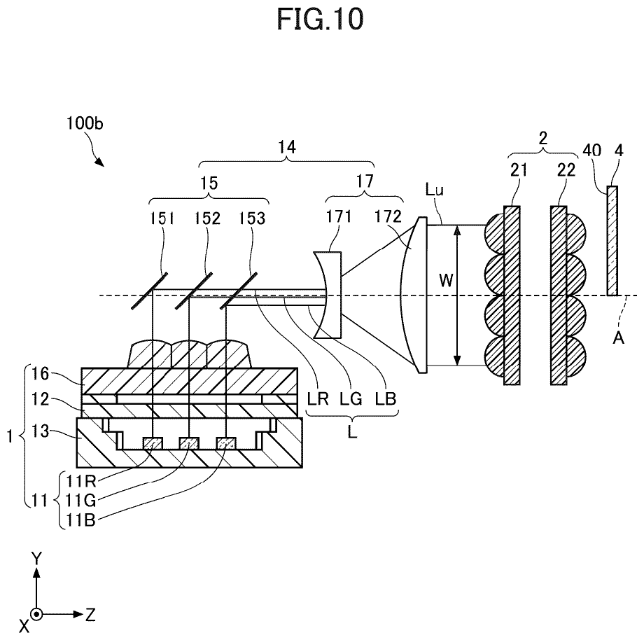

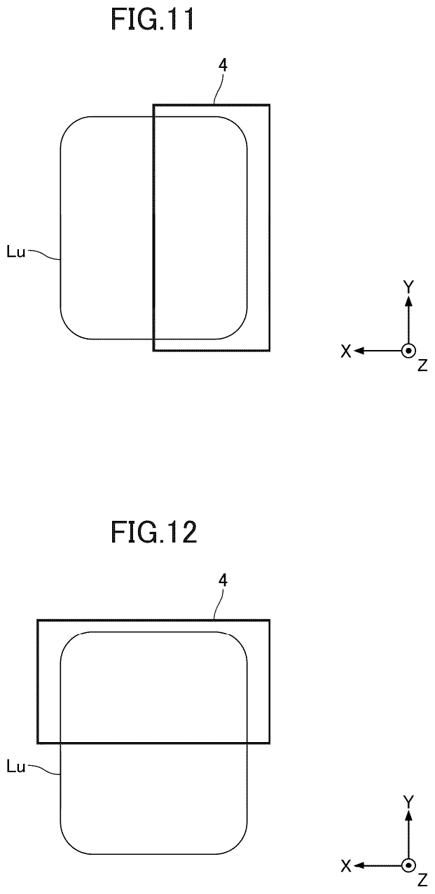

An optical device according to a third embodiment will be described with reference to FIG. 9 to FIG. 12. FIG. 9 schematically illustrates a cross-sectional view of an optical device 100b according to the third embodiment, illustrating a first example of the configuration of a laser light source 1 and the vicinity thereof. FIG. 10 schematically illustrates a schematic sectional view of the optical device 100b according to the third embodiment, illustrating a second example of the configuration of the laser light source 1 and the vicinity thereof in the optical device 100b. Each of FIG. 9 and FIG. 10 illustrates a cross section of the laser light source 1 and the vicinity thereof taken along an imaginary plane (for example, the YZ plane) including an optical axis A of the optical device 100b. The configuration of the optical device 100b other than the configuration of the laser light source 1 and the vicinity thereof may be the same as that of the optical device 100 according to the first embodiment. FIG. 11 schematically illustrates a plan view of the optical device 100b, illustrating a first example of the positional relationship between combined light Lu and the retardation plate 4 in the optical device 100b. FIG. 12 schematically illustrates a plan view of the optical device 100b, illustrating a second example of the positional relationship between the combined light Lu and the retardation plate 4 in the optical device 100b.

In the present embodiment, the optical device 100b further includes an optical combiner 14 disposed between the laser light source 1 and the first optical integrator 2 and configured to combine a plurality of laser light beams L so as to form combined light Lu. The retardation plate 4 transmits a portion of the combined light Lu of the plurality of laser light beams L, combined by the optical combiner 14, so as to rotate the polarization of the transmitted portion of the combined light Lu by 90 degrees. These points are different from the first embodiment.

If the retardation plate 4 is disposed so as to transmit a portion of each of the plurality of laser light beams, it would be necessary to position the retardation plate 4 with respect to each of the plurality of laser light beams with high accuracy, and thus it would take time to position the retardation plate 4. Further, if the positioning accuracy is low, the speckle noise reduction effect would be reduced. Conversely, in the present embodiment, the retardation plate 4 is disposed so as to transmit a portion of the combined light Lu. Thus, the retardation plate 4 for reducing speckle noise can be disposed easily with more tolerance in positional accuracy, as compared to when the retardation plate 4 is disposed so as to transmit a portion of each of the plurality of laser light beams.

In the first example of the optical device 100b illustrated in FIG. 9 and the second example of the optical device 100b illustrated in FIG. 10, the laser light source 1 emits a plurality of laser light beams L having different colors. The optical combiner 14 includes a mirror group 15 that combines the plurality of laser light beams L having the different colors. Further, the optical combiner 14 includes a beam expander 17 configured to increase the maximum width of the combined light of the plurality of laser light beams L in a direction orthogonal to an optical axis A of the optical device 100b. In the first example illustrated in FIG. 9 and the second example illustrated in FIG. 10, the mirror group 15 is disposed between the laser light source 1 and the first optical integrator 2. Further, the beam expander 17 is disposed between the mirror group 15 and the first optical integrator 2.

In the first example illustrated in FIG. 9 and the second example illustrated in FIG. 10, the mirror group 15 includes a mirror 151, a first dichroic mirror 152, and a second dichroic mirror 153. The mirror 151 reflects first laser light LR emitted from a first semiconductor laser element 11R toward the beam expander 17. The first dichroic mirror 152 reflects second laser light LG emitted from a second semiconductor laser element 11G toward the beam expander 17, and transmits the first laser light LR reflected by the mirror 151. The second dichroic mirror 153 reflects third laser light LB emitted from a third semiconductor laser element 11B toward the beam expander 17, and transmits the first laser light LR reflected by the mirror 151 and the second laser light LG reflected by the first dichroic mirror 152. The mirror 151 may be a dichroic mirror.

The first laser light LR, the second laser light LG, and the third laser light LB are combined by the mirror group 15 so as to form the combined light Lu. The combined light Lu is light in which red light, green light, and blue light are mixed and is substantially parallel to the optical axis A. The combined light Lu is incident on the beam expander 17. The mirror group 15 is not limited to one including the mirror 151, the first dichroic mirror 152, and the second dichroic mirror 153 as long as the mirror group 15 can combine the plurality of laser light beams L having the different colors. For example, the number and the arrangement of mirrors and dichroic mirrors may be changed as appropriate according to the number and the arrangement of the semiconductor laser elements 11 included in the laser light source 1.

The beam expander 17 includes a concave lens 171 and a convex lens 172. The beam expander 17 increases the maximum width of the combined light Lu from the mirror group 15 in the direction orthogonal to the optical axis A. The combined light Lu whose maximum width is increased by the beam expander 17 is also light substantially parallel to the optical axis A. A width W of the combined light Lu in each of the first example illustrated in FIG. 9 and the second example illustrated in FIG. 10 represents the maximum width of the combined light Lu increased by the beam expander 17. The beam expander 17 is not limited to one including the concave lens 171 and the convex lens 172 as long as the beam expander 17 can increase the maximum width of incident light in the direction orthogonal to the optical axis A. For example, the beam expander 17 may include two or more convex lenses.

The optical combiner 14 includes the mirror group 15, and thus can combine the plurality of laser light beams L having the different colors, which are emitted from the laser light source 1. Thus, when the plurality of laser light beams L having the different colors are used, the retardation plate 4 for reducing speckle noise can be disposed easily with more tolerance in positional accuracy. Further, the optical combiner 14 includes the beam expander 17, and thus the combined light Lu whose maximum width is increased in the direction orthogonal to the optical axis A can be obtained. Accordingly, the retardation plate 4 for reducing speckle noise can be disposed easily with more tolerance in positional accuracy as compared to when the beam expander 17 is not included. The optical combiner 14 does not have to include both the mirror group 15 and the beam expander 17, and may include at least one of the mirror group 15 or the beam expander 17.

In the first example illustrated in FIG. 9, the retardation plate 4 is disposed between the optical combiner 14 and the first optical integrator 2. The combined light Lu combined by the optical combiner 14 is perpendicularly incident on an incident surface 40 of the retardation plate 4. As illustrated in FIG. 11 and FIG. 12, the retardation plate 4 can transmit a portion of the combined light Lu combined by the optical combiner 14. In the example illustrated in FIG. 11, the shape of the retardation plate 4 in a plan view is a substantially rectangular shape with the longer side being in the vertical direction (for example, the Y direction), and the retardation plate 4 can transmit one-half, in the lateral direction (for example, the X direction), of the combined light Lu combined by the optical combiner 14. In contrast, in the example illustrated in FIG. 12, the shape of the retardation plate 4 in a plan view is a substantially rectangular shape with the longer side being in the lateral direction, and the retardation plate 4 can transmit one-half, in the vertical direction, of the combined light Lu combined by the optical combiner 14.

In the first example illustrated in FIG. 9, the combined light Lu combined by the optical combiner 14 is perpendicularly incident on the incident surface 40 of the retardation plate 4, and thus the retardation plate 4 can give a phase difference of a half wavelength to the combined light Lu with high accuracy. Accordingly, the retardation plate 4 can rotate the polarization direction of the combined light Lu transmitted therethrough by 90 degrees with high accuracy, and thus the speckle noise reduction effect of the optical device 100b can be increased.

In the second example illustrated in FIG. 10, the retardation plate 4 is disposed on the side (for example, the +Z side) of the first optical integrator 2 opposite to the side (for example, the −Z side) on which the optical combiner 14 is disposed. For example, when the retardation plate 4 is disposed between the optical combiner 14 and the first optical integrator 2, the combined light Lu, which is substantially parallel light, is incident on the retardation plate 4, Thus, there may be a case where the amount of scattered light of the combined light Lu may be increased at the end portion of the retardation plate 4, for example, at the end portion on the −Y side of the retardation plate 4. If scattered light is superimposed on laser light L emitted from the optical device 100b, the quality of the laser light L emitted from the optical device 100b would be degraded.

In the second example illustrated in FIG. 10, the retardation plate 4 is disposed on the side of the first optical integrator 2 opposite to the side on which the optical combiner 14 is disposed. Thus, scattering of the combined light Lu at the end portion of the retardation plate 4 can be reduced as compared to when the retardation plate 4 is disposed between the optical combiner 14 and the first optical integrator 2. Accordingly, the amount of scattered light superimposed on laser light L emitted from the optical device 100b can be reduced, and thus the quality of the laser light L emitted from the optical device 100b can be improved. The other effects of the optical device 100b according to the second example are the same as or similar to the effects of the optical device 100b according to the first example.

### Fourth Embodiment

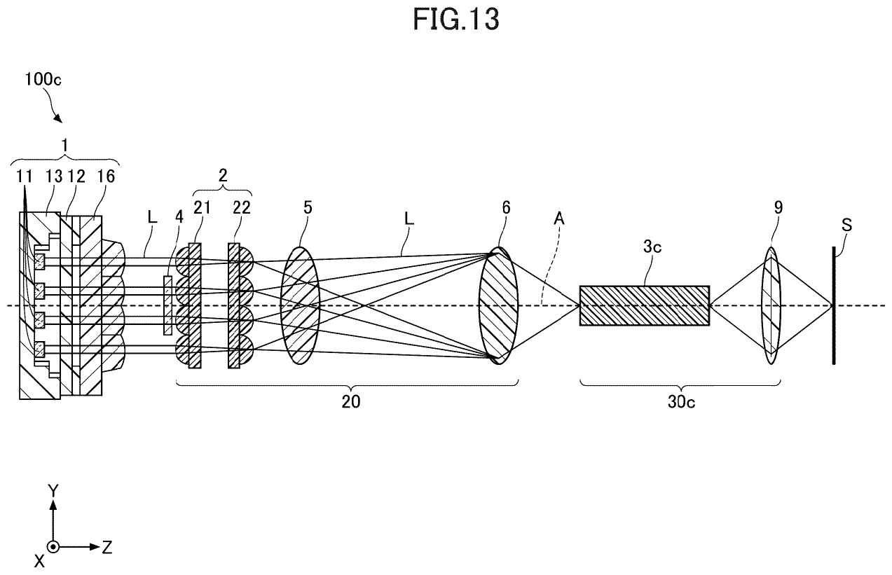

FIG. 13 schematically illustrates a cross-sectional view of an optical device 100c according to a fourth embodiment. FIG. 13 illustrates a cross section of the optical device 100c taken along an imaginary plane (for example, the YZ plane) including an optical axis A of the optical device 100c.

The fourth embodiment differs from the first embodiment in that the optical device 100c includes a second optical integrator 3c including a light pipe.

In the example illustrated in FIG. 13, the optical device 100c includes a fifth lens 9 and the second optical integrator 3c including the light pipe. The light pipe is, for example, a rod lens or a hollow light pipe. The second optical integrator 3c and the fifth lens 9 constitute a second illumination optical system 30c. Laser light L emitted from the laser light source 1 and transmitted through the first illumination optical system 20 is incident on the irradiation surface S through the second illumination optical system 30c.

In the optical device 100c, the speckle noise reduction effect by polarization multiplexing can be obtained by allowing the retardation plate 4 disposed between the laser light source 1 and the second optical integrator 3c to transmit a portion of the laser light so as to rotate the polarization of the transmitted portion of the laser light L by 90 degrees.

### Fifth Embodiment

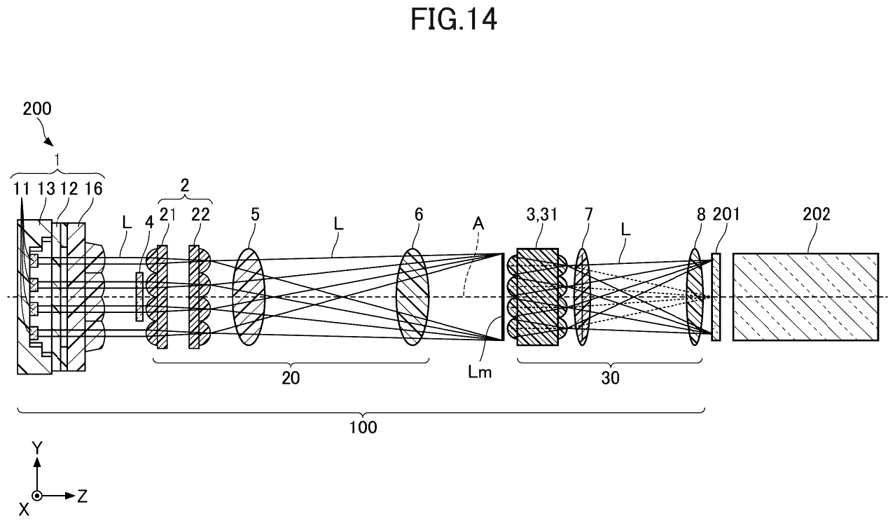

FIG. 14 schematically illustrates a cross-sectional view of a display device 200 according to a fifth embodiment. FIG. 14 illustrates a cross section of the display device 200 taken along an imaginary plane (for example, the YZ plane) including the optical axis A of the optical device 100.

The fifth embodiment differs from the first embodiment in that the display device 200 includes the optical device 100, a spatial modulator 201 configured to generate an image by modulating the spatial intensity distribution of the laser light L from the optical device 100, and a lens 202 configured to project the image generated by the spatial modulator 201.

The spatial modulator 201 includes a liquid crystal display (LCD), a digital micromirror device (DMD), and the like. The display device 200 is, for example, a projector. The display device 200 can display the image generated by the spatial modulator 201 onto a projection surface such as a screen by allowing the lens 202 to project the image onto the projection surface.

The laser light L emitted from the optical device 100 to the spatial modulator 201 is less likely to generate speckle noise by utilizing polarization multiplexing and angular multiplexing. Therefore, the display device 200 can project an image with reduced speckle noise onto the projection surface, and thus can display, on the projection surface, a high-quality image in which luminance unevenness and color unevenness caused by speckle noise are reduced.

The display device 200 does not have to include the optical device 100, and may include any of the optical device 100a, the optical device 100b, and the optical device 100c.

Although embodiments have been described in detail above, the present disclosure is not limited to the above-described embodiments, and various modifications and substitutions can be made to the above-described embodiments without departing from the scope described in the claims.

The numbers such as ordinal numbers and quantities used in the description of the embodiments are all exemplified to specifically describe the technique of the present disclosure, and the present disclosure is not limited to the exemplified numbers. In addition, the connection relationship between the components is illustrated for specifically describing the technique of the present disclosure, and the connection relationship for implementing the functions of the present disclosure is not limited thereto.

In the optical devices according to the present disclosure, speckle noise reduction performance can be improved, and thus the optical devices according to the present disclosure can be suitably used as light source devices in various apparatuses, devices, or systems using laser light. For example, the optical devices according to the present disclosure can be suitably used as light source devices in display devices such as projectors or head-up displays, head-mounted type display devices such as head-mounted displays, or the like. In addition, the optical devices according to the present disclosure can be used as light source devices in lighting systems such as lighting devices, smart lightings, or energy-saving lightings, drawing devices installed in vehicles or aircrafts, spatial three-dimensional drawing devices, underwater drawing systems, or the like.

According to one or more embodiments of the present disclosure, an optical device, in which speckle noise reduction performance can be improved, can be provided.

What is claimed is:

1. An optical device comprising:
a laser light source;
a first optical integrator configured to transmit laser light emitted from the laser light source;
a second optical integrator configured to transmit the laser light transmitted through the first optical integrator; and
a retardation plate disposed between the laser light source and the second optical integrator, and configured to transmit a portion of the laser light so as to rotate a polarization of the transmitted portion of the laser light by 90 degrees.

2. The optical device according to claim 1, wherein the retardation plate transmits one-half of the laser light.

3. The optical device according to claim 1, wherein
the laser light source is a light emitting device including a plurality of semiconductor laser elements, and
the laser light emitted from the light source comprises laser light beam emitted from each of the plurality of semiconductor laser elements.

4. The optical device according to claim 1, wherein
the laser light beam emitted from each of the plurality of semiconductor laser elements is separately incident on the retardation plate, and
the retardation plate transmits one-half of the laser light beam emitted from each of the plurality of semiconductor laser elements.

5. The optical device according to claim 1, wherein
the laser light source is a light emitting device including a plurality of semiconductor laser elements, and
the laser light emitted from the light source comprises laser light beam emitted from the at least one semiconductor laser element of the plurality of semiconductor laser elements.

6. The optical device according to claim 5, wherein the retardation plate is disposed so as to transmit one-half of the laser light emitted from the at least one semiconductor laser element of the plurality of semiconductor laser elements.

7. The optical device according to claim 1, wherein the laser light source emits a plurality of laser light beams having different colors.

8. The optical device according to claim 7, wherein
the laser light beams of different colors are separately incident on the retardation plate, and
the retardation plate transmits one-half of each of the laser light beams of the different colors.

9. The optical device according to claim 1, wherein
the retardation plate is disposed in a first region on a plane perpendicular to an optical axis of the optical device and no retardation plate is disposed in a second region on the plane, the first and second regions being adjacent to each other with a line passing the optical axis therebetween.

10. The optical device according to claim 1, wherein the retardation plate is disposed between the laser light source and the first optical integrator.

11. The optical device according to claim 10, wherein each of the first and second optical integrators includes one or more fry-eye lenses and one or more lenses following the one or more fry-eye lenses in a light transmitting direction.

12. The optical device according to claim 1, wherein the retardation plate is disposed between the first optical integrator and the second optical integrator.

13. The optical device according to claim 12, wherein each of the first and second optical integrators includes one or more fry-eye lenses and one or more lenses following the one or more fry-eye lenses in a light transmitting direction.

14. The optical device according to claim 1, further comprising:
an optical combiner disposed between the laser light source and the first optical integrator, and configured to combine a plurality of laser light beams so as to form combined light, wherein
the retardation plate transmits a portion of the combined light of the plurality of laser light beams so as to rotate a polarization of the transmitted portion of the combined light by 90 degrees.

15. The optical device according to claim 14, wherein
the plurality of laser light beams emitted from the laser light source have different colors, and
the optical combiner includes a mirror group configured to combine the plurality of laser light beams having the different colors.

16. The optical device according to claim 14, wherein the optical combiner includes a beam expander configured to increase a maximum width of the combined light in a direction orthogonal to an optical axis of the optical device.

17. The optical device according to claim 14, wherein
the retardation plate is disposed between the optical combiner and the first optical integrator, and
the combined light through the optical combiner is perpendicularly incident on an incident surface of the retardation plate.

18. The optical device according to claim 14, wherein the retardation plate is disposed on a side of the first optical integrator opposite to a side on which the optical combiner is disposed.

19. A display device comprising:
the optical device of claim 1;
a spatial modulator configured to generate an image by modulating spatial intensity distribution of the laser light from the optical device; and
a lens configured to project the image generated by the spatial modulator.
